(19) United States
(12) Patent Application Publication
(10) Pub. No.: US 2022/0309034 A1
(43) Pub. Date: Sep. 29, 2022

(54) METHOD AND SYSTEM FOR PERFORMING UNIFICATION PROCESSING ON MULTI-FORMAT LOGS IN SECURITY SITUATION AWARENESS SYSTEM

(71) Applicant: CRSC COMMUNICATION & INFORMATION GROUP COMPANY LTD., Beijing (CN)

(72) Inventors: Zhanbin LI, Beijing (CN); Han DONG, Beijing (CN); Guodong NI, Beijing (CN); Tianjiao YANG, Beijing (CN); Xinmu ZHANG, Beijing (CN)

(21) Appl. No.: 17/594,860

(22) PCT Filed: Apr. 30, 2020
(86) PCT No.: PCT/CN2020/087927

§ 371 Date: Nov. 1, 2021

(30) Foreign Application Priority Data
Nov. 6, 2019 (CN) 201911076092.0

(51) Int. Cl. G06F 16/11; G06F 3/14; H04L 67/06; G06F 16/17

(52) U.S. Cl. CPC G06F 16/116; G06F 3/14; H04L 67/06; G06F 16/1734

(57) ABSTRACT

A method and system for uniformly processing logs of multiple formats under a security situation awareness system. The method includes defining a universal interface file and an interface file that corresponds to each device ID of each vendor; collecting log files of respective vendors; putting a file transfer protocol into the collected log files and the defined universal interface file; reading, when change of any log file is monitored, the log file line by line, and updating the log file through the file transfer protocol; identifying a corresponding device ID; screening out an interface file corresponding to the device ID; based on the screened interface file, converting the updated log file into an interpretable uniform format in terms of the universal interface file; and displaying graphically a log file resulted from the uniform format, and completing a uniform processing with respect to the logs of multiple formats.

### FIELD OF THE INVENTION

The present disclosure relates to a method and system for uniformly processing logs of multiple formats under a security situation awareness system.

### BACKGROUND OF THE INVENTION

A security situational awareness system is used to process log reports of firewalls, zombie worm systems, and traffic cleaning that are provided by various vendors. Log formats of these vendors are diverse, confusing and complex, including a syslog (i.e., a system log or a system record), a custom text format, an Excel report and a Word report, etc. It is a troublesome problem regarding how to import these multifarious and various formats into the security situation awareness system in a uniform manner. Therefore, a method for uniformly processing the log formats is needed so that log reports processed through this method is more regular and easier for usage of a user. However, there is no such method for processing the log formats in a uniform manner in the prior art.

### SUMMARY OF THE DISCLOSURE

In view of the above problem, the present disclosure aims to provide a method and system for uniformly processing logs of multiple formats under a security situation awareness system so that processed log reports are more regular and easier for usage.

To achieve the above objective, the present disclosure implements a technical process as following. A method for uniformly processing logs of multiple formats under a security situation awareness system, characterized by including steps of: 1) defining a universal interface file and an optional interface file that corresponds to each device ID of each vendor, the universal interface file being configured to describe a log file and provide a unified intelligent identification interface for every vendor; 2) collecting log files of respective vendors; 3) putting a file transfer protocol into the collected log files and the defined universal interface file, respectively; 4) reading, when change of any log file is monitored, the log file line by line, and updating the log file through the file transfer protocol; 5) comparing the updated log file with the universal interface file, and identifying a device ID corresponding to the updated log file; 6) screening out an optional interface file corresponding to the device ID in terms of the device ID corresponding to the updated log file; 7) based on the screened optional interface file, converting the updated log file into an interpretable uniform format in terms of the universal interface file, and storing the interpretable uniform format in a database; and 8) displaying graphically a log file resulted from the uniform format, and completing a uniform processing with respect to the logs of multiple formats.

Further, a specific process of the step 1) includes that: 1.1) defining the universal interface file which includes a compulsory part and an optional part, the compulsory part including a device ID, a log type ID, and a multi-element set, the multi-element set including a start time, a duration information, a source IP and a target IP, and the optional part including a custom log format configured to describe a detailed log format and a log conversion package; and 1.2) defining the optional interface file corresponding to each device ID of each vendor, each optional interface file including an engine type, a network type, a protocol type, a source IP, a source port, a target IP, a target port, a vendor ID and a device ID.

Further, the custom log format of the optional part includes two types, i.e., using a predefined GROK expression; or converting Excel and Word into a database format through a JAR package processing interface.

Further, a specific process of the step 5) includes that: 5.1) comparing a log format of the updated log file with the compulsory part of the universal interface file; 5.2) if the log format of the log file has been defined in the compulsory part of the universal interface file, identifying a device ID corresponding to the updated log file, and then proceeding to step 6); if the log format of the log file is not defined in the compulsory part of the universal interface file, then proceeding step 5.3); and 5.3) querying the optional part of the universal interface file, and identifying a device ID corresponding to the updated log file in terms of the custom log format in the optional part of the universal interface file, and then proceeding to step 6).

A system for uniformly processing logs of multiple formats under a security situation awareness system is characterized by including: an interface file defining module configured to define an universal interface file and an optional interface file that corresponds to each device ID of each vendor, the universal interface file being configured to describe a log file and provide a unified intelligent identification interface for every vendor; a log collecting module configured to collect, in real time, and update log files of respective vendors; a log processing module configured to compare an updated log file with the universal interface file, and identify a device ID corresponding to the updated log file; an optional interface screening module configured to screen out, in terms of the device ID corresponding to the updated log file, an optional interface file corresponding to the device ID; a format unifying module configured to convert, based on the screened optional interface file, the updated log file into an interpretable uniform format in terms of the universal interface file, and store the interpretable uniform format in a database; and a display module configured to graphically display a log file resulted from the uniform format.

Further, the interface file defining module includes a universal interface file defining unit configured to define a universal interface file, the universal interface file including a compulsory part and an optional part, the compulsory part including a device ID, a log type ID and a multi-element set, the multi-element set including a start time, a duration information, a source IP and a target IP, and the optional part including a custom log format configured to describe a detailed log format and a log conversion package; and an optional interface file defining unit configured to define an optional interface file corresponding to each device ID of each vendor, each optional interface file including an engine type, a network type, a protocol type, a source IP, a source port, a target IP, a target port, a vendor ID, and a device ID.

Further, the log collecting module includes a log collecting unit configured to collect log files of respective vendors; a log updating unit configured to read, when change in any log file is monitored, the log file line-by-line, and update the log file through a file transfer protocol.

Further, the log processing module includes a comparison unit configured to compare a log format of the updated log file with the compulsory part of the universal interface file; a compulsory part processing unit configured to identify, when the log format of the updated log file has been defined in the compulsory part of the universal interface file, a device ID corresponding to the updated log file; and an optional part processing unit configured to query, when the log format of the updated log file is not defined in the compulsory part of the universal interface file, the optional part of the universal interface file, and identify a device ID corresponding to the updated log file in terms of the custom log format in the optional part of the universal interface file.

A computer program is characterized by including computer program instructions, wherein the computer program instructions are configured to, when being executed by a processor, implement the steps of the above method for uniformly processing logs of multiple formats.

A computer-readable storage medium is characterized by storing computer program instructions thereon, wherein the computer program instructions are configured to, when being executed by a processor, implement the steps corresponding to the above method for uniformly processing logs of multiple formats.

By using these above, the present disclosure has the following advantages: 1. An original log is analyzed in the present disclosure so that a log file that should have had a complex log form becomes more concise and regular and is readily needed by a user, and an outcome obtained according to the present disclosure can be further enriched and labeled. 2. The processed log file is displayed graphically in the present disclosure so that it is easier for an user to perceive security situation of an existing network, security operation and maintenance personnel are facilitated to find threats and take measures in time so as to help an customer to effectively insight into external threats and internal vulnerable risks suffered by an enterprise, an efficiency of monitoring, management, and handling of security incidents by the security operation and maintenance team is also improved greatly, and thus there is an extensive applicability in the field of security situational awareness.

### BRIEF DESCRIPTION OF THE DRAWINGS

FIG. 1 is a schematic flow chart of a method according to the present disclosure.

### DETAILED DESCRIPTION OF THE EMBODIMENTS

The present disclosure will be described in detail with reference to the drawings below. However, it should be understood that the drawings are only provided for a better understanding of the present disclosure other than limitation to the present disclosure.

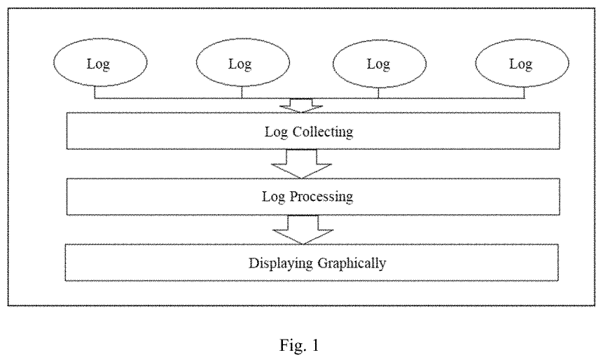

As shown in FIG. 1, a method for uniformly processing logs of multiple formats under a security situation awareness system provided by the present disclosure includes the following steps.

1) A universal interface file and an optional interface file that corresponds to each device ID of each vendor are defined, respectively. The universal interface file is configured to describe a log file and provide a unified intelligent identification interface for every vendor. The optional interface file is configured to correspond to a specific model of product of a vendor. Each product is equipped with several optional interface files. Specifically,

1.1) The universal interface file is defined, which including a compulsory part and an optional part:

1.1.1) The compulsory part includes {device ID, log type ID, multi-element set}. The multi-element set includes a start time, a duration information, a source IP and a target IP. The device ID and the log type ID use a predefined system of situational awareness. When the device ID and the log type ID each match IDs of the predefined system, it means a format is known, and the predefined system can be used for analysis of a log format; when neither the device ID nor the log type ID match the IDs of the predefined system, a custom log format of the optional part may be applied for the analysis.

1.1.2) The optional part includes {custom log format} which is configured to describe a detailed log format and a log conversion package. Two types of custom log formats are provided. One adopts predefined GROK expression, and the other converts Excel and Word to a sql database format through a JAR package (i.e., a software package file format) processing interface.

1.2) The optional interface file corresponding to each device ID of each vendor is defined:

An optional interface corresponds to a specific model of product of a vendor, and is configured to reflect the vendor's actual business. Each optional interface file includes an engine type, a network type, a protocol type, a source IP, a source port, a target IP, a target port, a vendor ID and a device ID, etc. For example, interpretation for every field of an optional interface file of a certain vendor is as following:

| Index | Parameter Name | Description | Data Type |
|---|---|---|---|
| 1 | ENGINE_TYPE | Compulsory field; Engine type | String |
| | | (engine types are managed | |
| | | unifiedly by a platform to | |
| | | identify different engines) | |
| 2 | SIGNATURE | Signature library | String |
| | LIBRARY | version No. | |
| | VERSION No. | | |
| 3 | RID | Rule ID targeted by an | String |
| | | alarm and associated with | |
| | | a signature database | |
| 4 | NETOWORK | Network type: Ipv4 | String |
| | TYPE | | |
| 5 | PROTOCOL | Compulsory field; Protocol | String |
| | | type, such as HTTP, FTP, | |
| | | SMTP, POP | |
| 6 | SIPv4 | Compulsory field of IPV4; | String; |
| | | Source IP | Dotted |
| | | | decimal |
| 7 | SIPv6 | Compulsory field of IPV6; | String; |
| | | Source IP | Hexadecimal |
| 8 | SP | Compulsory field; Source port | Number |
| 9 | DIPv4 | Compulsory field of IPV4; | String; |
| | | Target IP | Dotted |
| | | | decimal |
| 10 | DIPv6 | Compulsory field of IPV6; | String; |
| | | Target IP | Hexadecimal |
| 11 | DP | Compulsory field; Target port | Number |
| 12 | TIME | Log time of UTC format | String |
| | | (yyyy-mm-dd HH:mi:ss) | |
| 13 | VENDORID | Compulsory field; Vendor ID | String |
| 14 | DEVID | Compulsory field; Device ID | String |
| | | (an unique identifier of an | |
| | | engine device) | |
| 15 | PROVINCEID | Compulsory field; Province | String |
| | | ID, see province codes in | |
| | | Appendix 2 | |
| 16 | URL | HTTP protocol is URL that is | String |
| | | accessed to, other protocols | |
| | | are null | |
| 17 | NAME | Event name | String |
| 18 | TYPE | Type | StringSS |

Every field of an optional interface file of another vendor may be interpreted as following:

| Field name | Type | Description |
|---|---|---|
| srcip | % s | Source IP address |
| dstip | % s | Target IP address |
| sport | % u | Source port (ICMP protocol port is a type value) |
| dport | % u | Target port (ICMP protocol port is a code value) |
| proto | % s | Protocol type name (TCP, UDP, etc.) |
| eventname | % s | Event name |
| seclevel | % u | Event severity level |
| action | % s | Intrusion event handling action: Drop means |
| | | blocking, Accept means passing |
| hitcount | % d | The number of occurrences of the same type |
| | | of event within a configured time (default 5 |
| | | seconds) |
| sigID | % u | Signature ID, i.e., sID |
| groupID | % u | Group ID of a signature |
| user | % s | Username |
| policyID | % u | Strategy ID |

Formats of respective vendors' logs are different from each other, and an individual vendor has its own format. These optional interface file exactly correspond to a real log of vendor's product and reflect the real business situation of the vendor.

2) Log files of respective vendors are collected.

3) A FTP (File Transfer Protocol) protocol is put into the collected log files and the defined universal interface file, respectively.

4) When change of any log file is monitored by a monitoring plug-in, this log file is read line by line and updated through the FTP protocol.

5) The updated log file is compared with the universal interface file, and a device ID corresponding to the updated log file is identified, specifically:

5.1) A log format of the updated log file is compared with the compulsory part of the universal interface file.

5.2) If the log format of the log file has been defined in the compulsory part of the universal interface file, a device ID corresponding to the updated log file is identified, and then it proceeds to step 6); if the log format of the log file is not defined in the compulsory part of the universal interface file, then it proceeds step 5.3).

5.3) The optional part of the universal interface file is queried, and a device ID corresponding to the updated log file is identified in terms of a custom log format in the optional part of the universal interface file, and then it proceeds to step 6).

6) An optional interface file corresponding to the device ID is screened out in terms of the device ID corresponding to the updated log file so that a matching of following step 7) is speeded up and a vendor and a product model that the updated log file corresponds to can be identified. In the case, only when the optional interface file corresponding to the device ID has been screened out, can how to interpret the device be known so that the matching in step 7) can be speeded up. The optional interface file corresponds to the device ID in a one-to-one manner, and each device ID corresponds to one optional interface file.

7) Based on the screened optional interface file, the updated log file is converted into an interpretable uniform format in terms of a GrokParser (a parsing configuration method) expression or a JAR processing interface that is specified in the optional part of the universal interface file, and stored it in a sql database.

8) A log file resulted from the uniform format is graphically displayed, and a uniform processing with respect to logs of multiple formats is completed.

Application of the method for uniformly processing logs of multiple formats under a security situation awareness system provided by the present disclosure will be described in detail through a specific embodiment below.

In the method of the present disclosure, enrichment and labeling may be carried out after the uniform processing with respect logs of multiple formats is completed. An enrichment is mainly applied on the optional part of the universal interface file to enrich an IP address into an actual geographic location or a physical geographic location, such as a local IP: 223.72.73.226 CMCC (China Mobile Communications Group) of Xicheng District, Beijing, so that a log file can be effectively presented as a graphic. Another typical enrichment is an IP-user correspondence table, e.g., 223.**226 in the above example belonging to an user of CMCC; an user-industry correspondence table, e.g., the user of CMCC in the above example belonging to the operator industry; an enrichment related to this field may be added during the enrichment.

Labeling is to form log order numbers after all log files are stored. Each time one log is generated, one order number is formed. The order numbers are incremented. Each time there is one additional log, once index increment will be performed. The labeling is a prerequisite for searching logs in a sequential manner, and also a start for querying after the logs are normalized.

A main flow regarding enrichment and labeling is as following:

A) After a log file monitored by a monitoring plug-in is analyzed using the provided method, enrichment and labeling are to be performed.

B) The enrichment is responsible for mapping an IP to a key user, such as a key user name, an asset type, and a bandwidth.

C) Logs of interest or all log files are indexed and stored in a database or a big data platform for easy of indexing later.

Based on the above method for uniformly processing logs of multiple formats under a security situation awareness system, further provided by the present disclosure is a system for uniformly processing logs of multiple formats under a security situation awareness system, including:

an interface file defining module, which is configured to define an universal interface file and an optional interface file that corresponds to each device ID of each vendor, the universal interface file being configured to describe a log file and provide a unified intelligent identification interface for every vendor; a log collecting module, which is configured to collect, in real time, and update log files of respective vendors; a log processing module, which is configured to compare an updated log file with the universal interface file, and identify a device ID corresponding to the updated log file; an optional interface screening module, which is configured to screen out, in terms of the device ID corresponding to the updated log file, an optional interface file corresponding to the device ID; a format unifying module, which is configured to convert, based on the screened optional interface file, the updated log file into an interpretable uniform format in terms of the universal interface file and store it in a database; and a display module, which is configured to graphically display a log file resulted from the uniform format.

In a preferred embodiment, the interface file defining module includes: a universal interface file defining unit, which is configured to define a universal interface file, the universal interface file including a compulsory part and an optional part, the compulsory part including a device ID, a log type ID and a multi-element set, the multi-element set including a start time, a duration information, a source IP and a target IP, the optional part including a custom log format configured to describe a detailed log format and a log conversion package; and an optional interface file defining unit, which is configured to define an optional interface file corresponding to each device ID of each vendor, each optional interface file including an engine type, a network type, a protocol type, a source IP, a source port, a target IP, a target port, a vendor ID, and a device ID.

In a preferred embodiment, the log collecting module includes: a log collecting unit, which is configured to collect log files of respective vendors; a log updating unit, which is configured to read, when change in any log file is monitored, the log file line-by-line, and update the log file through a file transfer protocol.

In a preferred embodiment, the log processing module includes: a comparison unit, which is configured to compare a log format of the updated log file with the compulsory part of the universal interface file; a compulsory part processing unit, which is configured to identify, when the log format of the updated log file has been defined in the compulsory part of the universal interface file, a device ID corresponding to the updated log file; and an optional part processing unit, which is configured to query, when the log format of the updated log file is not defined in the compulsory part of the universal interface file, the optional part of the universal interface file, and identify a device ID corresponding to the updated log file in terms of the custom log format in the optional part of the universal interface file.

Provided is a computer program including computer program instructions, wherein the computer program instructions are configured to, when being executed by a processor, implement the steps of the above method for uniformly processing logs of multiple formats.

Provided is a computer-readable storage medium on which computer program instructions are stored, wherein the computer program instructions are configured to, when being executed by a processor, implement the steps corresponding to the above method for uniformly processing logs of multiple formats.

The foregoing embodiments are only used to illustrate the present disclosure. The structure, connection mode and manufacturing process of each component can be changed. Any equivalent modifications and improvements made on the basis of the technical solution of the present disclosure should not be excluded outside the protection scope of the present disclosure.

1. A method for uniformly processing logs of multiple formats under a security situation awareness system, wherein, the method comprises steps of:
1. defining a universal interface file and an optional interface file that corresponds to each device ID of each vendor, wherein the universal interface file is configured to describe a log file and provide a unified intelligent identification interface for every vendor;
2. collecting log files of respective vendors;
3. putting a file transfer protocol into the collected log files and the defined universal interface file, respectively;
4. reading, when change of any log file is monitored, the log file line by line, and updating the log file through the file transfer protocol;
5. comparing the updated log file with the universal interface file, and identifying a device ID corresponding to the updated log file;
6. screening out an optional interface file corresponding to the device ID in terms of the device ID corresponding to the updated log file;
7. converting, based on the screened optional interface file, the updated log file into an interpretable uniform format in terms of the universal interface file, and storing the interpretable uniform format in a database; and
8. displaying graphically a log file resulted from the uniform format, and completing a uniform processing with respect to the logs of multiple formats.

2. A method for uniformly processing logs of multiple formats under a security situation awareness system according to claim 1, wherein, a specific process in the step 1) including:
1.1) defining the universal interface file which includes a compulsory part and an optional part:
the compulsory part including a device ID, a log type ID, and a multi-element set, the multi-element set including a start time, a duration information, a source IP and a target IP; and
the optional part including a custom log format configured to describe a detailed log format and a log conversion package; and
1.2) defining the optional interface file corresponding to each device ID of each vendor, each optional interface file including an engine type, a network type, a protocol type, a source IP, a source port, a target IP, a target port, a vendor ID and a device ID.

3. A method for uniformly processing logs of multiple formats under a security situation awareness system according to claim 2, wherein, the custom log format of the optional part includes two types:
using a predefined GROK expression; or converting Excel and Word into a database format through a JAR package processing interface.

4. A method for uniformly processing logs of multiple formats under a security situation awareness system according to claim 2, wherein, a specific process in the step 2) including:
5.1) comparing a log format of the updated log file with the compulsory part of the universal interface file;
5.2) if the log format of the log file has been defined in the compulsory part of the universal interface file, identifying a device ID corresponding to the updated log file, and then proceeding to step 6); if the log format of the log file is not defined in the compulsory part of the universal interface file, then proceeding step 5.3); and
5.3) querying the optional part of the universal interface file, and identifying a device ID corresponding to the updated log file in terms of the custom log format in the optional part of the universal interface file, and then proceeding to step 6).

5. A system for uniformly processing logs of multiple formats under a security situation awareness system, wherein, the system comprises:
an interface file defining module configured to define an universal interface file and an optional interface file that corresponds to each device ID of each vendor, wherein the universal interface file is configured to describe a log file and provide a unified intelligent identification interface for every vendor;
a log collecting module configured to collect, in real time, and update log files of respective vendors;
a log processing module configured to compare an updated log file with the universal interface file, and identify a device ID corresponding to the updated log file;
an optional interface screening module configured to screen out, in terms of the device ID corresponding to the updated log file, an optional interface file corresponding to the device ID;
a format unifying module configured to convert, based on the screened optional interface file, the updated log file into an interpretable uniform format in terms of the universal interface file, and store the interpretable uniform format in a database; and
a display module configured to graphically display a log file resulted from the uniform format.

6. A system for uniformly processing logs of multiple formats under a security situation awareness system according to claim 5, wherein, the interface file defining module includes:
a universal interface file defining unit configured to define a universal interface file, wherein the universal interface file includes a compulsory part and an optional part, the compulsory part includes a device ID, a log type ID and a multi-element set, the multi-element set includes a start time, a duration information, a source IP and a target IP; and the optional part includes a custom log format configured to describe a detailed log format and a log conversion package; and
an optional interface file defining unit configured to define an optional interface file corresponding to each device ID of each vendor, wherein each optional interface file includes an engine type, a network type, a protocol type, a source IP, a source port, a target IP, a target port, a vendor ID, and a device ID.

7. A system for uniformly processing logs of multiple formats under a security situation awareness system according to claim 5, wherein, the log collecting module includes:
a log collecting unit configured to collect log files of respective vendors; and
a log updating unit configured to read, when change in any log file is monitored, the log file line-by-line, and update the log file through a file transfer protocol.

8. A system for uniformly processing logs of multiple formats under a security situation awareness system according to claim 5, wherein, the log processing module includes:
a comparison unit configured to compare a log format of the updated log file with the compulsory part of the universal interface file;
a compulsory part processing unit configured to identify, when the log format of the updated log file has been defined in the compulsory part of the universal interface file, a device ID corresponding to the updated log file; and
an optional part processing unit configured to query, when the log format of the updated log file is not defined in the compulsory part of the universal interface file, the optional part of the universal interface file, and identify a device ID corresponding to the updated log file in terms of the custom log format in the optional part of the universal interface file.

9. A computer program comprising computer program instructions, wherein, the computer program instructions are configured to, when being executed by a processor, implement steps of the method for uniformly processing logs of multiple formats according to claim 1.

10. A computer-readable storage medium on which computer program instructions are stored, wherein, the computer program instructions are configured to, when being executed by a processor, implement steps of the method for uniformly processing logs of multiple formats according to claim 1.
